(19) United States
(12) Patent Application Publication
(10) Pub. No.: US 2026/0056279 A1
(43) Pub. Date: Feb. 26, 2026

(54) Multi-Node Based Distance Measurement

(71) Applicant: TEXAS INSTRUMENTS INCORPORATED, Dallas, TX (US)

(72) Inventor: Tomas Motos, Hamar (NO)

(21) Appl. No.: 19/047,825

(22) Filed: Feb. 7, 2025

Related U.S. Application Data
(60) Provisional application No. 63/685,476, filed on Aug. 21, 2024.
(60) Provisional application No. 63/726,816, filed on Dec. 2, 2024.

(51) Int. Cl. G01S 5/02; G08B 13/24; H04W 4/029

(52) U.S. Cl. CPC G01S 5/0284; G08B 13/2462; H04W 4/029

(57) ABSTRACT

A system includes an initiator, a reflector, and one or more passive nodes. The initiator and the reflector may participate in a channel sounding procedure, and the one or more passive nodes may listen in on the channel sounding procedure. The passive nodes may measure phase offset relative to their local oscillators and then transmit phase data to the initiator, the reflector, and/or a control node separate from the initiator and the reflector. The device receiving the phase data may then use that phase data to calculate distance and, from the distance, calculate spatial position. The system may be used to calculate a position of the initiator or of the reflector.

### CROSS-REFERENCE TO RELATED APPLICATIONS

The present application claims the benefit of U.S. Provisional Patent Application 63/685,476, filed Aug. 21, 2024, and claims the benefit of U.S. Provisional Patent Application 63/726,816, filed Dec. 2, 2024, the disclosures of which are hereby incorporated by reference in their entireties.

### TECHNICAL FIELD

The present disclosure relates generally to an electronic system and method, and, in particular embodiments, to a multi-node based distance measurement.

### BACKGROUND

In some applications, it may be necessary to measure a distance to a wireless device or between two wireless devices.

### SUMMARY

In accordance to an embodiment, an electronic device includes: a processor; and a wireless communication interface coupled to the processor, where the processor is configured to: receive control data indicating time and frequency parameters for a phase-based ranging operation between a first wireless device and a second wireless device; monitor, using the wireless communication interface, the phased-based ranging operation between the first and second wireless devices according to the time and frequency parameters, including receiving a first continuous wave signal from the first wireless device and receiving a second continuous wave signal from the second device, via the communication interface; and generate phase data based on receiving the first continuous wave signal and the second continuous wave signal.

In accordance to an embodiment, a system includes: a first device configured to perform a channel sounding procedure, including transmitting a first continuous wave signal, and receiving a second continuous wave signal from a second device; and a third device configured to monitor the channel sounding procedure, including determining a first phase associated with the first continuous wave signal and a second phase associated with the second continuous wave signal.

In accordance to an embodiment, an electronic device includes: a processor; and a communication interface coupled to the processor, where the processor is configured to: perform a tone exchange, via the communication interface, with a first wireless device during a connection event between the electronic device and the first wireless device; determine a first distance from the electronic device to the first wireless device based on the tone exchange; receive phase data from a second wireless device, where the phase data from the second wireless device is based on the continuous wave signals of the tone exchange relative to a local oscillator of the second wireless device, and where the connection event is exclusive of the second wireless device; receive phase data from a third wireless device, where the phase data from the third wireless device is based on the continuous wave signals of the tone exchange relative to a local oscillator of the third wireless device, and where the connection event is exclusive of the third wireless device; determine a second distance from the second wireless device to the first wireless device based on the phase data from the second wireless device; determine a third distance from the third wireless device to the first wireless device based on the phase data from the third wireless device; and determine a spatial position of the first wireless device based on the first, second, and third distances.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 shows an exemplary wireless system for performing distance measurement;

FIG. 2 shows a system, according to an embodiment of the present disclosure; and

FIG. 3 shows a vehicle, according to an embodiment of the present disclosure;

FIG. 4 shows a door access system, according to an embodiment of the present disclosure;

FIG. 5 shows a warehouse tracking system, according to an embodiment of the present disclosure;

FIG. 6 shows a packet and tone exchange between an initiator and a reflector, according to an embodiment of the present disclosure;

FIGS. 7-9 show packet and tone exchanges between an initiator and a reflector, according to embodiments of the present disclosure; and

FIG. 10 shows an example method for operation of a passive device, according to an embodiment of the present disclosure.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

In some applications, it may be desirable to measure the distance to a wireless device or between two wireless devices. For example, a system may measure the distance between it and a key fob or phone that is attempting to access the system, to confirm the proximity of the key fob before granting access rights. One such example is a passive keyless entry system, e.g., for automobiles. Other examples include room access (such as hotel room access), or other access control systems. In order to maximize the accuracy of the estimations, multiple measurements on multiple frequencies may be performed.

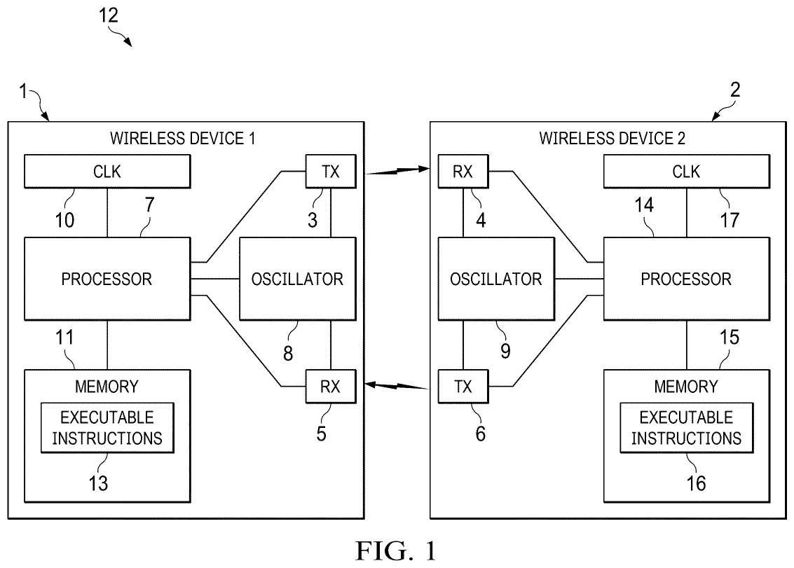

FIG. 1 shows exemplary wireless communications system 12 having wireless communications devices 1 and 2. Device 1 includes transmitter 3 and receiver 5 and device 2 includes transmitter 6 and receiver 4. Transmitters 3 and 6 may be, for example, radio frequency (RF) transmitters. Receivers 4 and 5 may be, for example, RF receivers. Devices 1 and 2 each have an oscillator 8 and 9, respectively, for generating RF signals. Oscillators 8 and 9 may be, for example, phase-locked loops (PLLs) capable of generating sine waves. Device 1 may also include a processor 7, a memory 11 and a clock 10. Device 2 may also include a processor 14, a memory 15 and a clock 17. Processors 7 and 14 may be configured, for example, to perform the distance measurement calculations. Memories 11 and 15 include executable instructions 13 and 16, respectively, and may comprise a non-transitory storage device such as volatile memory (e.g., random access memory) or non-volatile memory (e.g., read only memory). Receivers 4 and 5 and transmitters 3 and 6 may act as wireless communication interfaces in this example.

Each of processors 7 and 14 may be implemented with one or more generic or custom processor or controller capable of executing instruction of memories 11 and 15, respectively. Each of processors 7 and 14 may be implemented with a field programmable gate array (FPGA). Each of processors 7 and 14 may include a finite state machine (FSM). In some embodiments, each of processors 7 and 14 includes a controller used to implement the lower layers (e.g., physical (PHY) and data link/MAC layers) of a communication stack (e.g., a Bluetooth Low Energy (BLE) stack), and a processor communicative coupled to such controller and implementing the higher layers (e.g., network, transport, and application layers) of the communication stack.

Device 1 may be, for example, a master device, and device 2 may be, for example, a slave device. Device 2 may be, for example, a key fob or phone and device 1 may be incorporated into a vehicle (e.g., automobile, truck, boat, airplane, etc.). It may be desirable for the device 1 to determine, for example, a distance to device 2 to determine if device 2 is close enough to grant access permission. If device 1 is incorporated into a vehicle, device 1 may permit the doors to be unlocked and/or the motor to be engaged upon determining that the device 2 is sufficiently close to device 1.

Devices 1 and 2 may communicate using Bluetooth Low Energy (BLE) protocol. Other standard or proprietary protocols may be used. For examples, protocols such as Bluetooth classic, WiFi, Ultra-wideband (UWB), or the like, may be used by devices 1 and 2 to communicate with each other.

Distance measurement may be performed based on the phase shift of incoming signals. In an example, processor 7 of device 1 instructs oscillator 8 to generate a continuous wave signal (CW), which may be an unmodulated RF carrier signal. Transmitter 3 of device 1 receives the CW from oscillator 8 and sends the CW to device 2. Receiver 4 of device 2 detects the CW and measures the frequency of the CW and the phase of the CW with respect to a local phase of oscillator 9, which receiver 4 received from oscillator 9. Receiver 4 then provides the measured values to processor 14. Processor 14 then instructs oscillator 9 to generate a CW with the same frequency and phase as the CW received from wireless device 1, and that CW is then sent to device 1. Device 2 then sends local phase information to device 1 by any known method (e.g., Bluetooth/BLE, WiFi, wired connection, etc.). Using its own local phase information and the local phase information received from device 2, device 1 then uses processor 7 to calculate the phase shift of a received CW, which may be the same for both CWs in the exchange.

A CW sent from device 1 to device 2 may have its local phase shifted or rotated by the same amount as a CW traveling from device 2 to device 1. Receiver 5 of device 1 measures the phase of the incoming CW with respect to the local phase of the oscillator 8. Similarly, receiver 4 of device 2 measures the phase of the incoming CW with respect to the local phase of the oscillator 9. The relationship of the measured phases and of the incoming CWs to both local oscillator phases and the phase shift between devices may be defined as follows:

$${Φ}_{1} = {ψ}_{2} + θ - {ψ}_{1} \qquad ( 1 )$$

$${Φ}_{2} = {ψ}_{1} + θ - {ψ}_{2} \qquad ( 2 )$$

where Φ₁ and Φ₂ are the phases of the incoming CWs measured at devices 1 and 2, respectively, θ is phase shift as the CW travels between devices, and ψ₁ and ψ₂ are the local phases of oscillators 8 and 9, respectively. After device 2 sends the measured Φ₂ to device 1, device 1 may calculate the phase shift α by using the Equation 3, which is a combination of Equations 1 and 2:

$$θ = \frac{{Φ}_{1} + {Φ}_{2}}{2} \qquad ( 3 )$$

The phase shift or rotation of the CW as it travels between the devices may be proportional to the distance between the devices. The phase shift θ of a CW between device 1 and device 2 may also be expressed as:

$$θ = \frac{2 π f r}{c} mod 2 π \qquad ( 4 )$$

where c is the speed of light, f is the frequency of the CW and r is the distance between the devices. Using Equation 4, the distance between the devices may be expressed as:

$$r = \frac{c θ}{2 π f} mod \frac{c}{f} \qquad ( 5 )$$

Due to the spatial periodicity of the RF signals, a single phase shift measurement at a single frequency may be able to determine a precise distance once an approximate distance is known. However, because some techniques are unable to distinguish between phase shifts that are separated by multiples of half the CW period, a single measurement may yield multiple possible locations, each separated by a half wavelength of the CW. If the CW is, for example, in the 2.4 GHz industrial, scientific and medical (ISM) band and the distance is considered in bins of about 6 cm, a single measurement may determine where the distance falls within a bin but be unable to determine which bin the distance falls in. Multiple measurements in multiple frequencies may be performed to improve accuracy. Where two different CW exchanges are performed using two different frequencies, the distance may be calculated using Equation 6:

$$r = \frac{c Δθ}{2 π Δ f} mod \frac{c}{Δ f} \qquad ( 6 )$$

where Δθ is the difference in the two measured phase shifts for CWs in two different CW exchanges and Δf is the difference between the frequencies. With a Δf of approximately 1 MHz, the distance r may be able to be determined within a bin of around 300 meters. Thus, two measurements provide increased range compared to a single measurement.

As illustrated and described with respect to FIG. 1, using phase-based distance measurements may involve two nodes (devices 1 and 2). Devices 1 and 2 may exchange CWs (e.g., unmodulated carrier signals) between them and measure the local phase related to a local oscillator (LO) signal.

The exchange may involve:
(1) device 1 sending a first CW signal while device 2 listens to the first CW signal and records the relative phase between the received first CW signal and an LO signal (e.g., generated by 9) of device 2;
(2) device 1 and device 2 switching roles, so that device 1 becomes the receiver and device 2 becomes the transmitter. Both devices keep their respective LO running during this period;
(3) device 2 sending a second CW signal while device 1 listens to the second CW signal and records the relative phase between the received second CW signal and an LO signal (e.g., generated by 8) of device 1; and
(4) repeating steps 1-3 for multiple frequencies.

This procedure involves active participation of both nodes (devices 1 and 2), as both transmit a local CW signal on their appointed periods. This procedure also computes a distance estimate between two wireless devices.

Propagation conditions, however, might result in difficult communication conditions between devices 1 and 2. Examples of these could be non-line-of-sight (nLOS) conditions or deep fading conditions.

It may be advantageous to enable the observation of the phase measurements from additional vantage points. If N additional nodes were to observe and compute the distance to device 2 at no additional communication cost, then the overall distance measurement may be significantly and advantageously improved in terms of both accuracy and energy.

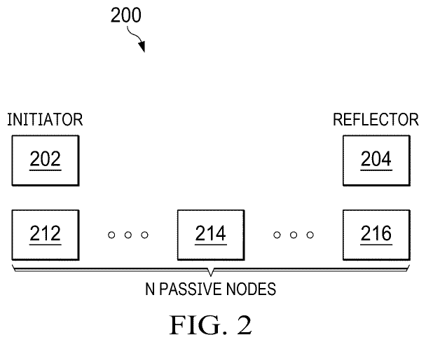

FIG. 2 shows system 200, according to an embodiment of the present disclosure. System 200 includes device 202 (acting as initiator), device 204 (acting as a reflector), and N passive devices (acting as passive listeners). FIG. 2 shows 3 passive devices (devices 212, 214, and 216), however, some embodiments may be implemented with 1 or 2 passive devices, or with more than 3 passive devices (e.g., 4, 5, 6, 10 or more). In some embodiments, device 202 may act as a reflector while device 204 may act as the initiator.

Each of devices 202 (initiator), 204 (reflector), and the N passive devices (e.g., 212, 214, 216) may be implemented or include a circuit such as device 1 or device 2 of FIG. 1.

In some embodiments, system 200 is a vehicle that includes devices 202, and the N passive devices, while device 204 is a smartphone or key fob, e.g., requesting access to the vehicle.

In some embodiments, the initiator (e.g., device 202) takes the overall responsibilities for the measurements; the reflector (e.g., device 204) actively answers the initiator's requests, and the N passive devices listen to the requests and answers from devices 202 and 204.

In some embodiments, the initiator (e.g., 202) and the passive devices (e.g., 212, 214, 216) have a relationship (e.g., a BLE communication link and/or controller area network (CAN) communication link) established a priori. In some embodiments, the distances between the device 202 (e.g., the initiator) and each of the passive nodes (e.g., 212, 214, 216) is known (e.g., fixed and stored to memory). The positions of device 204 (e.g., the reflector) with respect to device 202 (e.g., the initiator) and the passive nodes (212, 214, 216) may be arbitrary, and may vary.

In some embodiments, the passive nodes may not have an active wireless communication link with the initiator and/or reflector. For example, in some embodiments, the passive nodes may not perform wireless transmissions that interfere with the wireless exchanges between the initiator and reflector devices and may not have an active wireless connection with the initiator and/or the reflector. For example, the passive nodes may be in receive mode only during wireless exchanges between the initiator and the reflector devices. The passive nodes may transfer data collected during the initiator/reflector exchange to the device performing the distance estimation (e.g., the initiator, the reflector, or a computing node/device external to the initiator and reflector) using wired communication (e.g., any time) or using wireless communication, e.g., after the wireless exchange between the initiator and reflector.

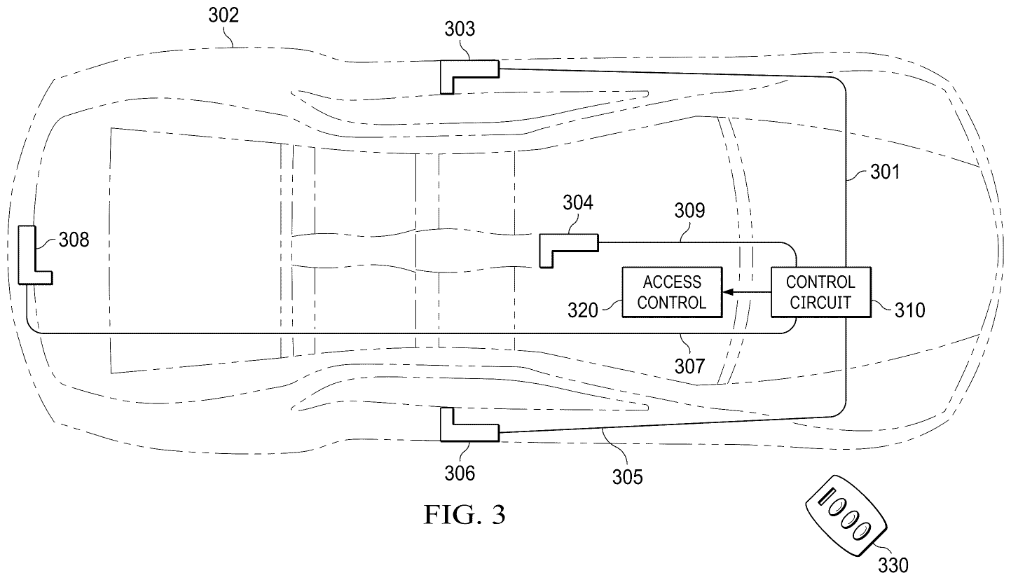

In some embodiments, the initiator (e.g., 202) collects data from the passive nodes and performs a determination of the location of the reflector (e.g., 204) based on the collected data. In some embodiments, the reflector (e.g., 204) collects data from the passive nodes and performs a determination of the location of the initiator (e.g., 202) based on the collected data. In some embodiments, another device (e.g., 310 of FIG. 3), separate from any of devices 202, 204, 212, 214, 216 may collect data from the passive nodes and perform a determination of the location of the reflector or initiator. In yet another example embodiment, anyone of the passive nodes 212, 214, or 216 may collect data from the other nodes (e.g., passive nodes, reflector, and/or initiator) and perform a determination of the location of the reflector or initiator.

The system illustrated in FIG. 2 may be implemented, e.g., for access control in a vehicle or building/room, and/or to identify/track devices, e.g., inside a building/room, such as in a warehouse.

FIG. 3 shows vehicle 302, according to an embodiment of the present disclosure. System 200 may be implemented as vehicle 302. Vehicle 302 includes devices 303, 304, 306, and 308, control circuit 310, and access control circuit 320.

Devices 303, 304, 306, and 308 are mounted within vehicle 302 at the locations as shown or at different locations within the vehicle 302. In some embodiments, each of devices 303, 304, 306, and 308 is a BLE device.

Control circuit 310 is responsible for performing measurement calculations, and may be implemented inside one of devices 303, 304, 306, and 308, or external to them.

The access control mechanism 320 is coupled to the control circuit 310 and controls one or more functions of the vehicle 302 such as unlocking the doors and/or permitting the vehicle's motor to be started. For a vehicle with an internal combustion engine, the access control mechanism 320 permits the engine to be started such as by turning a key in the ignition or pressing a “start” button. For an electric vehicle, the access control mechanism 320 permits the vehicle's electric motor to be activated.

In some embodiments, control circuit 310 (e.g., implemented inside one of devices 303, 304, 306 or 308, or external to devices 303, 304, 306, or 308) causes control mechanism 320 to control one or more functions of the vehicle 302 based on a detection of a particular device 330 at a predetermined location (e.g., closer than a predetermined distance to a particular origin, or in a particular area with respect to the particular origin). In some embodiments, detection of the particular target may be based on a packet exchange, such as based on the authentication of a particular sequence transmitted by device 330.

In some embodiments, devices 303, 304, 306, and 308 may be connected to a communication bus (e.g., a CAN bus), as shown by bus 301, 305, 307, and 309. In some embodiments, such wired communication may be omitted and devices 303, 304, 306, and 308 may communicate wirelessly, e.g., via BLE or other standard or proprietary wireless communication protocol.

In vehicle 302, one of devices 303, 304, 306 or 308 may be selected for communication exchange with device 330 (e.g., as the initiator or reflector), and the rest of such devices may act as passive nodes (e.g., 212, 214, 216).

In some embodiments, device 330 (e.g., which may be a key fob, a smart phone, or a device acting or including a key fob) may act as the reflector, and the device selected to communicate with device 330 may act as the initiator. In some embodiments, device 330 may act as the initiator and the device selected to communicate with device 330 may act as the reflector.

In some embodiments, regardless of which device is acting as the reflector and which as the initiator, one of devices 303, 304, 306, 308, or 310) may collect data from the passive nodes and perform a distance/location/position estimation to the initiator.

In some embodiments, the device selected for communicating with device 330 is selected (e.g., from devices 303, 304, 306, and 308) based on which device receives the first communication from device 330, which device is closer to 330 (e.g., based on time-of-flight determination or some other determination mechanism), or based on other criteria). For example, in some embodiments, the device selected to communicate with device 330 is predetermined and fixed.

For purposes of the following description, devices associated with the distance evaluation are labelled with numbers, from 0 to N, where device 0 is the Initiator (e.g., one of devices 303, 304, 306 or 308), and devices 1 to N are the passive nodes (e.g., the others of devices 303, 304, 306, and 308). The reflector (e.g., 330) is identified by letter B. The distance from device 0 to B is labeled as r₀. The distance from device k to B is labeled as rₖ, where k is in [1,N] range and represents any arbitrary passive node.

The distance from device 0 to all the passive nodes is labeled as r₀ₖ (r₀₁ is the distance from the Initiator to passive Node 1, etc.). In some embodiments, all the r₀ₖ distances are known, e.g., by control circuit 310, e.g., at the system definition. In some examples, a distance being known may include that distance being pre-set or fixed and the data representing that distance being stored to a memory accessible to one or more devices.

Using Equation 4, The phase rotation between the Reflector B and all the other nodes may be expressed as:

$${θ}_{k} = \frac{2 π {fr}_{k}}{c} \qquad ( 7 )$$

Similarly, the phase rotation between the Initiator 0 and the passive nodes may be expressed as:

$${θ}_{0 k} = \frac{2 π {fr}_{0 k}}{c} \qquad ( 8 )$$

In some embodiments, all the nodes involved in the communication start the measurements with arbitrary local phases of their respective local oscillators (LOs) and the LOs being set to a same frequency. For the purpose of this discussion, these local phases are labelled as ψ, where ψ₀ represents the LO phase for the initiator, ψ_{B} represents the LO phase for the Reflector, and ψₖ the LO phases for each of the passive nodes.

When the LO signal of device 0 travels to device B, its phase shifts by the phase rotation proportional to the distance and frequency (θ₀), so that ψ₀ becomes ψ₀+θ₀. Equally, when the LO signal from device B travels to device 0, its phase shifts by the same amount (θ₀), so that ψ_{B} becomes ψ_{B}+θ₀.

Each of these devices may be configured to measure those incoming phases in respect to their LO. The following relationships between device 0 (e.g., Initiator) and B (e.g., Reflector) in this example:

$${PCT}_{0} = {ψ}_{B} + {θ}_{0} - {ψ}_{0} \qquad ( 9 )$$

$${PCT}_{B} = {ψ}_{0} + {θ}_{0} - {ψ}_{B} \qquad ( 10 )$$

where PCT stands for Phase Correction Term and refers to the local measurement between the incoming radio frequency (RF) signal and the local LO signal.

By combining Equations 9 and 10, the value of 00 may be deduced, as shown in Equation 11:

$${PCT}_{0} + {PCT}_{B} = 2 {θ}_{0} \qquad ( 11 )$$

Note that 2 θ₀ corresponds to the two-way phase rotation (the rotation for the RF signal in its round trip from the Initiator to the Reflector and back).

Finding the phase rotation θ₀ may give a direct indication of the distance. In some examples, a frequency measurement may not be enough: multiple phases over multiple different carrier frequencies may be used to properly disambiguate the measurements.

By combining Equations 9 and 10 differently, a result that is proportional to the difference of the two local phases may be obtained by Equation 12.

$${PCT}_{0} - {PCT}_{B} = 2 ( {ψ}_{B} - {ψ}_{0} ) \qquad ( 12 )$$

The signals traveling from device 0 to device B may be passively observed by a given device k, and referred to its local oscillator, as shown in Equations 13 and 14:

$${PCT}_{Bk} = {ψ}_{B} + {θ}_{k} - {ψ}_{k} \qquad ( 13 )$$

$${PCT}_{0 k} = {ψ}_{0} + {θ}_{0 k} - {ψ}_{k} \qquad ( 14 )$$

These equations may be combined, so that:

$${CT}_{k} = 2 ( {PCT}_{BK} - {PCT}_{0 K} ) = 2 ( {ψ}_{B} - {ψ}_{0} ) + 2 ( {θ}_{k} - {θ}_{0 k} ) = {PCT}_{0} - {PCT}_{B} + 2 ( {θ}_{k} - {θ}_{0 k} ) \qquad ( 15 )$$

In some embodiments, all the terms of Equation 15 are known, except for θₖ, which may then be calculated. Thus:

$$2 {θ}_{k} = 2 ( {PCT}_{BK} - {PCT}_{0 K} ) + ( {PCT}_{B} - {PCT}_{0} ) + 2 {θ}_{0 k} \qquad ( 16 )$$

In some embodiments, the distance from vehicle 302 (e.g., from a predetermined point in vehicle 302) and key fob 330 may be determined as follows:
(a) device 0 and device B perform a tone exchange (e.g., using CW as explained above with respect to FIG. 1), and determining PCT₀ and PCT_{B} using Equations 9 and 10;
(b) while step (a) is taking place, all the passive devices observe their incoming signals and locally compute respective PCT_{Bk} and PCT₀ₖ using Equations 13 and 14;
(c) the passive nodes compute the correction term from Equation 15, CTₖ, using Equation 15 and then send the results to initiator (or control circuit 310), e.g., via CAN bus or wirelessly, e.g., using BLE or other wireless protocol;
(d) device B sends PCT_{B} to the initiator;
(e) a device (e.g., one of 303, 304, 306, 308, which may be a device acting as the initiator, or reflector, or a passive device, or device 310) collects all the data received from the devices (e.g., during steps (a)-(d), computes all the values from all devices, displaces them with the known phase shift (2 θ₀ₖ), and computes all distances using Equations 5 or 6 (e.g., the distances from each of devices 303, 304, 306, 308) and 330); and
(f) a device (e.g., one of 303, 304, 306, 308, which may be a device acting as the initiator, or reflector, or a passive device, or device 310) performs a distance/location/position estimation to the device 330 (e.g., which may acting as a reflector or initiator), e.g., with respect to the vehicle 302 (e.g., to a predetermined point in vehicle 302), based on the collection of the several measurements.

The tone exchange between the initiator and the reflector may be referred to as a channel sounding (CS) procedure.

Some embodiments advantageously allow for a device (e.g., a passive nodes, a control unit, or a device selected for the CS procedure (e.g., as initiator or reflector) of a system (e.g., vehicle 302) to estimate the distance to the device 330 based on the CS procedure combined with observations of the passive nodes taken by just listening to the exchange between the initiator and reflector (e.g., devices 1 and 2). The additional information obtained by the passive nodes may advantageously improve the accuracy of the location estimation of device 330 without additional tone exchanges (e.g., between any of the passive devices and the initiator and/or reflector).

Some embodiments may compute multiple distance values simultaneously, which may advantageously improve the accuracy of the overall measurement. For instance, multiple distance computations may be performed using the information from the multiple different passive nodes out of the same exchange. Nodes that are obscured (nLOS propagation conditions) or faded may be supplemented from other nodes in other physical positions.

In some embodiments, only two devices communicate together, whereas multiple (N) devices passively observe the interactions. From one single exchange, there may be a total of N+1 observations and distance computations, which may advantageously increase the accuracy of the measurements without substantially increasing energy consumption (e.g., since only 2 devices communicate together) and/or substantially decreasing the time for estimating the distance (e.g., since less number of CS exchanges may be used to obtain a target accuracy for the distance estimate.

Some embodiments may advantageously help in preventing a phase attack. For example, a phase attack may blindly manipulate phases for one receiver. However, when multiple spatial observations need to be disrupted (e.g., such as in systems 200, 300), it may become harder for an attacker to keep those disruptions properly aligned. Thus, some embodiments may advantageously increase the security of the system.

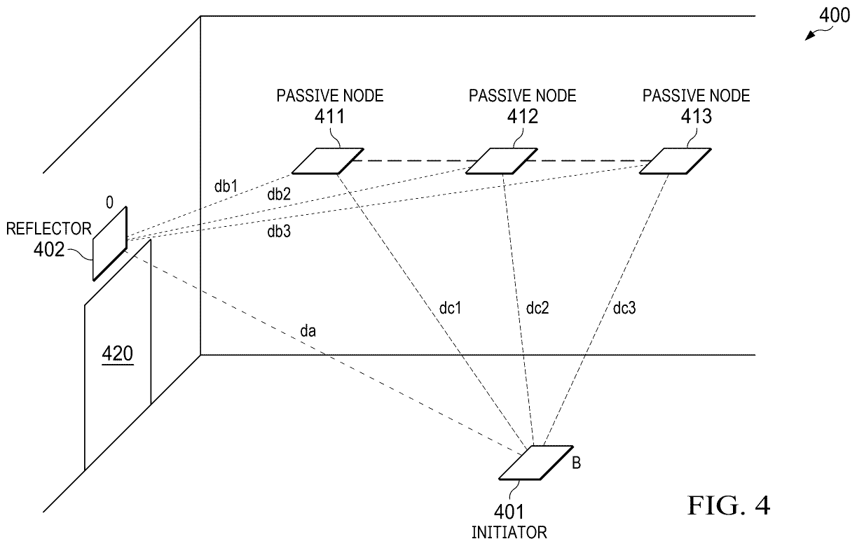

The systems and methods disclosed herein may be implemented in many applications, including a vehicle (e.g., FIG. 3), an access system (e.g., of a building/room, such as illustrated in FIG. 4) or a warehouse application (e.g., as illustrated in FIG. 4).

FIG. 4 is an illustration of an example use case for system 400 having an initiator, a reflector, and one or more passive nodes, according to some embodiments. System 400 may represent a room, a building, an elevator, or any other area in which access via an entry element (e.g., a door) is restricted or controlled.

In FIG. 4, the initiator 401 (node B) may be the target to be located. There is a reflector 402 (node 0) and one or more passive nodes 411-413 (1-N). In some embodiments, device 401 (e.g., the target to be located) may operate as a reflector and device 402 may operate as an initiator.

There may be a single channel sounding (CS) procedure/exchange between the initiator 401 and reflector 402. As in the other examples, each of the initiator 401, the reflector 402, and the passive nodes 411-413 may be implemented the same as or similar to devices 1 and 2 of FIG. 1. While FIG. 4 shows only three passive nodes 411-413, the scope of embodiments may be adapted to include any number of passive nodes N, where N is an integer 1 or greater.

In some embodiments, the initiator 401 sends all its local PCTs to the collector node (e.g., one of devices 402, 411, 412, 413, or external to devices 402, 411, 412, 413, such as a control circuit similar to 310 shown in FIG. 3, but not shown in FIG. 4) in charge of distance calculation (which may be device 402 (e.g., the reflector) or any other node). The collector node gathers all the PCTs from the passive nodes 411-413 and initiator 401 and computes distance/location. A single CS procedure may advantageously allow the collector node to generate multiple distances, such as da and dc1-3 (e.g., without having additional CS procedures between any of the passive nodes (411, 412, 413) and the initiator 401). In this example, distances db1-3 are known (e.g., known a priori, or determined out-of-band). As such, a single CS procedure may result in a position estimation through trilateration. The collector node, or another node not shown, may perform a control operation that includes analyzing the computed position and then either allowing door 420 to be opened or disallowing door 420 to be opened based on the analyzing.

For example, in some embodiments, door 420 may be controlled based on detection of a particular target detected at a particular location (e.g., closer than a predetermined distance to a particular origin, or in a particular area with respect to the particular origin). In some embodiments, detection of the particular target may be based on a packet exchange, such as based on the authentication of a particular sequence transmitted by device 401.

In some embodiments, device 401 (e.g., the initiator) may be a wireless access device (e.g., a phone, tag, key fob, card, or other wireless access device), carried by a human user, to provide that human user permission to open door 420 and enter a restricted area.

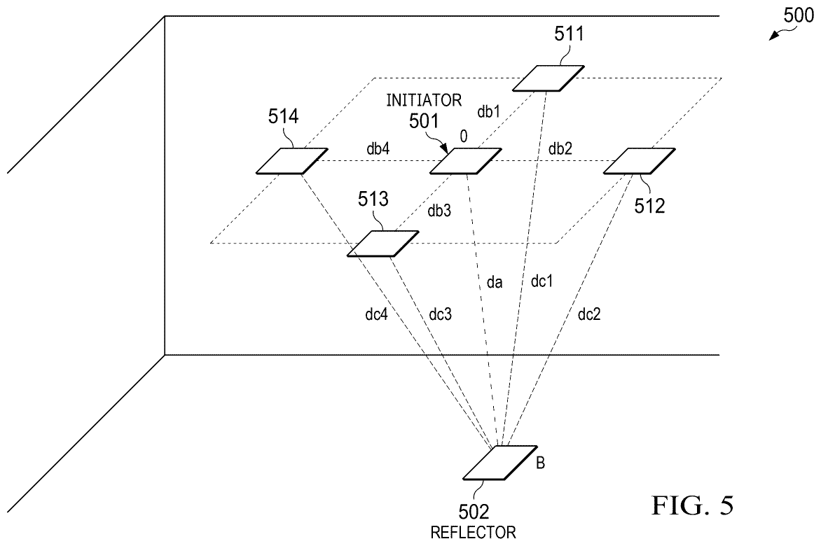

FIG. 5 is an illustration of an example use case for system 500 having an initiator, a reflector, and one or more passive nodes, according to some embodiments. System 500 may represent a room, a building, an elevator, or any other area (e.g., enclosed, partially enclosed, or outdoors).

In FIG. 5, the reflector 502 (node B) may be the target to be located. There is an initiator 501 (node 0) and one or more passive nodes 511-514 (1-N). In some embodiments, device 501 (e.g., the target to be located) may operate as a reflector and device 502 may operate as an initiator.

There may be a single CS procedure/exchange between the initiator 501 and reflector 502. As in the other examples, each of the initiator 501, the reflector 502, and the passive nodes 511-514 may be implemented the same as or similar to devices 1 and 2 of FIG. 1. While FIG. 5 shows only four passive nodes 511-514, the scope of embodiments may be adapted to include any number of passive nodes N, where N is an integer 1 or greater.

In this example, the system is implemented, e.g., in a warehouse to track, e.g., inventory. For instance, the reflector 502 may be an ID tag or other appropriate device, which is attached to a box, container, or directly to the inventory itself. In FIG. 5, the warehouse may be, e.g., 100×100 m (10000 m²), though the scope of implementations is not limited to any particular sized warehouse. Sensing nodes (nodes 501 and 511-514) on the ceiling may be disposed, e.g., every 10 meters, which may result in, e.g., 100 nodes in total. In some embodiments, e.g., 1000s of reflector nodes connect, e.g., every 10 minutes to report their physical location. Each procedure may involve 100 ms of connection time and 25 ms of CS procedure time. A set of passive nodes (e.g., 511-514 and others, not shown) may observe the CS procedure and report their respective correction terms (e.g., PCTs) to a collector node (e.g., part of initiator 501, part of devices 511, 512, 513 or 514, or external to devices 501, 511, 512, 513, and 514). The collector node may then determine multiple distances, such as da and dc1-4. In this example, db1-4 are known. The collector node may also use the distances to calculate positions, such as via trilateration. A computer system (not shown) may track the inventory/products associated with reflector 502 and the location of such inventory/products, as well as inventory associated with other reflectors (not shown).

In some embodiments, computing absolute position in space with a single CS procedure, with a ceiling height of 10 m, a distance between node of 10 meters, result in a do accuracy: 0.5 m (<% 95), d[1 . . . N] accuracy: 0.75 m (<95%). The scope of implementations is not limited to any number of nodes, spacing between the nodes, or size of a warehouse. Rather, the scope of implementations may be scaled as appropriate.

| N | 50% Percentile | 95% Percentile |
|---|---|---|
| 4 | 37 cm | 81 cm |
| 8 | 26 cm | 58 cm |

In some embodiments, the tone exchange and subsequent determination of distance/location disclosed herein may be used in combination with other ranging methods, such as round-trip time (RTT) measurements, to increase the accuracy of the ranging/location determination. For example, the exchange between the initiator and reflector may include, in addition to the tone exchange, a synchronization packet exchange used for RTT calculations, e.g., as disclosed in U.S. patent application Ser. No. 16/680,714, filed Nov. 12, 2019, now U.S. Pat. No. 11,366,216, assigned to Texas Instruments Incorporated, which application is incorporated herein by reference.

For example, the examples described above with respect to FIGS. 2-5, may employ a phase-based ranging technique to determine distances and then to determine positions, via trilateration, from the distances. Such calculations may be supplemented with the use of RTT measurements.

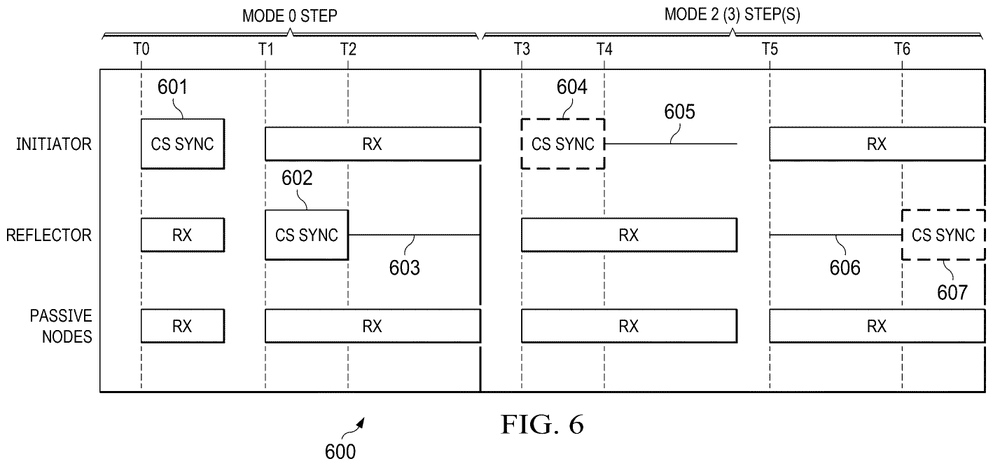

For example, FIG. 6 shows packet and tone exchange 600 between an initiator (e.g., 202), and a reflector (e.g., 204), with one or more passive nodes (e.g., 212, 214, 216) listening/monitoring the exchange, according to an embodiment of the present disclosure. FIG. 6 refers to modes, which may include modes of operation for BLE CS, though the scope of implementations is not limited to any particular protocol, such as BLE or Wi-Fi.

Before time T₀, the initiator and reflector are connected (e.g., the initiator and reflector have established a connection according to their communication protocol (e.g., BLE or Wi-Fi) and have exchanged information to facilitate the CS procedure). The passive nodes may or may not have connections to each other or to the initiator or reflector.

In some embodiments, during a time in which the initiator and reflector establish the connection, they may exchange control data representing time domain parameters (e.g., time offsets for transmission) and frequency domain parameters (e.g., channels to use) to indicate a timing for a packet or tone and a channel for the packet or tone. The parameters may also include encryption/authentication details (e.g., encryption keys), channel hopping sequence information, information indicating a frequency or frequencies when a sequence of channels is randomized, or any other control information to determine time domain and frequency domain characteristics of the toner packet. Such information may be exchanged wirelessly, according to the communication protocol, or by a wired medium (e.g., CAN bus, such as in FIG. 3). The passive nodes may receive the control data, e.g., representing the time domain parameters and frequency domain parameters, etc., either wired or wirelessly as well. In some embodiments, such control data or a portion thereof may be pre-programmed into the initiator, the reflector, and/or one or more (or all) of the passive nodes as appropriate.

As shown in FIG. 6, in one mode of operation (e.g., mode 0), a synchronization packet 601 is transmitted by the initiator at time T₀ and received by the reflector at some time after T₀. The reflector subsequently transmits another (e.g., identical) synchronization packet 602 at time T₁, followed by a tone 603 (illustrated as a line) at time T₂, which are then received by the initiator. The entire exchange may be monitored by the one or more passive devices, as shown in FIG. 4.

Similarly, at time T₃, the initiator may transmit synchronization packet 604 and then transmit tone 605 at time T₄, both of which may be received by the reflector. The reflector may then transmit tone 606 at time T₅ and then transmit synchronization packet 607 at time T₆, both of which may be received by the initiator. From time T₀ to time T₆, the passive nodes may listen to the transmissions without wireless transmissions of their own. For instance, from time T₀ to time T₆, the passive nodes may receive the packets 601, 602, 604, and 607 and the tones 603, 605, and 606 but without transmitting packets or tones themselves, at least during the CS procedure. However, the passive nodes may transmit in ways that do not interfere with the CS procedure, such as according to different time domain parameters and/or frequency domain parameters as those used by the CS procedure. For example, the passive nodes may transmit wireless signals in other frequency ranges (e.g., according to standard or proprietary communication protocols), or otherwise not interfering with the CS procedure.

In some embodiments, the one or more passive devices are capable of monitoring the exchange based on the control data. For example, in some embodiments, the one or more passive devices use timing information, channel hopping information, and/or encryption information to monitor packets 601, 602, 604, and 607, and tones 603, 605, and 606.

In some embodiments, the passive nodes may analyze the packets 601, 602, 604, and 607 and the tones 603, 605, and 606 to determine time of arrival (for the packets) and phase information (for the tones) and then transmit the results of the analysis to a device that determines position (e.g., the initiator, the reflector, or other device). The passive nodes may transmit the results of the analysis via a wired connection (e.g., CAN bus or ethernet) or wirelessly. The wireless communication may be according to the wireless protocol of the CS procedure or another wireless protocol.

As shown in FIG. 6, the tones 603, 605, 606 may be transmitted by the initiator (e.g., mode 2) and/or by the reflector (e.g., mode 0 or 2), and may be transmitted (e.g., immediately) before or (e.g., immediately) after the packets 601, 602, 604, 607. In some embodiments, the packet transmission may be omitted.

In some embodiments, the packet transmission may be used to measure RTT. The packets 601, 604 may first originate at the initiator and then the packets 602, 607 may be transmitted by the reflector in response to reception (e.g., as shown in mode 0). In some embodiments, the packets may first originate at the reflector and then be transmitted by the initiator in response to reception (not shown in FIG. 6).

In some embodiments, packets 601, 602, 604, 607 may include a predetermined sequence known a priori by the initiator and reflector.

In some embodiments, the predetermined sequence of packets 601, 602, 604 and 607 may be used to authenticate the initiator and/or reflector (e.g., by the reflector and/or the initiator).

In some embodiments, the tone exchange illustrated in FIG. 6 may be performed in a similar manner as described with respect to FIGS. 2 and 3. For example, in some embodiments, the one or more passive nodes (e.g., after aligning in time and frequency to the initiator and reflector according to the expected exchange) may perform measurements and transfer such measurements back to the device (e.g., initiator or reflector) performing the distance calculation. For instance, time-of-flight for a packet may be proportional to a distance between devices. The passive nodes may measure the time-of-flight and then provide that time-of-flight to another device that may calculate distance and/or position.

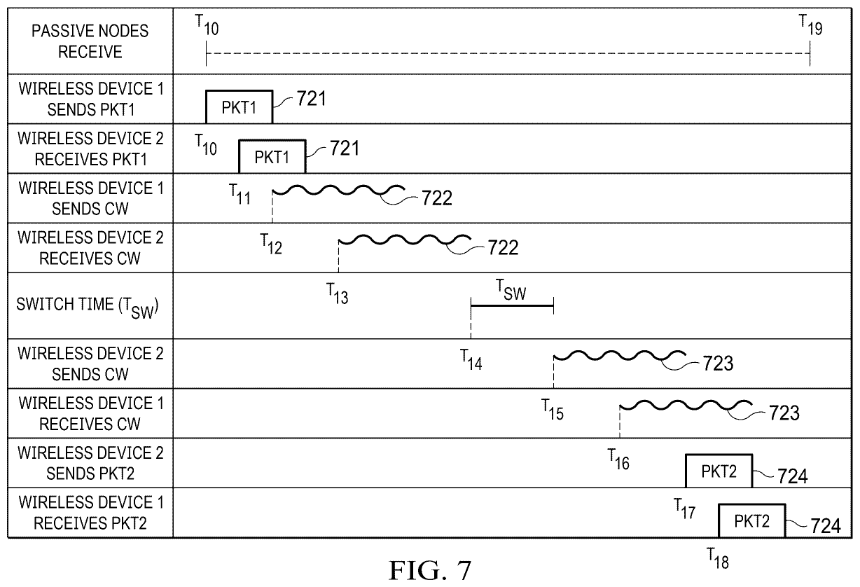

FIGS. 7-9 illustrate different techniques for timing of synchronization packets relative to CWs, according to some embodiments. For instance, in any of the embodiments discussed herein, a system having an initiator, a reflector, and one or more passive nodes may use such timing to perform both phase-based ranging with respect to the CWs and RTT with respect to the synchronization packets.

In the examples of FIGS. 7-9, wireless device 1 may correspond to any of the initiator devices discussed above and may be implemented the same as or similar to device 1 of FIG. 1, and wireless device 2 may correspond to any of the reflector devices discussed above and may be implemented the same as or similar to device 2 of FIG. 1. The passive devices may correspond to any of the passive devices discussed above and may be implemented the same as or similar to device 1 or device 2 of FIG. 1.

Further in this example, device 1 may be configured to calculate a distance from device 1 to device 2. Device 1 may also have known spatial relationships with the one or more passive nodes. The passive devices may record time-of-flight for the packets and transmit time-of-flight information to device 1. The passive devices may also record local phase data with respect to the CWs and transmit that local phase data to device 1. Device 1 may use the known spatial relationships with the one or more passive devices, the time-of-flight data that it receives from the one or more passive devices as well as a time-of-flight data that it records itself, and phase data that it receives from the one or more passive nodes as well as phase data that it receives from device 2 to determine a position of device 2. For instance, device 1, device 2, and the one or more passive nodes may be used to determine a position of device 2, using phase-based ranging based on CWs, as in the examples described above with respect to FIGS. 2-5. Furthermore, device 1 may convert time-of-flight data (e.g., clock ticks) into distance data to calculate distances between device 1 and device 2 as well as respective distances between the one or more passive nodes and device 2. Device 1 may then use those distances to calculate spatial position of device 2.

Before the devices transmit synchronization packets and CWs, the devices may exchange frequency domain data and time domain data to align the timing and frequency for transmission and reception of the packets and CWs. For instance, wireless device 1 and wireless device 2 may establish a connection according to a wireless protocol (e.g., BLE or Wi-Fi) and then exchange the frequency domain data and time domain data. The passive nodes may acquire the frequency domain data and time domain data in any appropriate manner, such as by listening into the connection, being pre-programmed with such data, and/or the like. In other words, for the CS and RTT procedure, the passive nodes have the frequency domain data and time domain data (e.g., and any encryption/decryption data/key, if applicable) necessary to allow the passive devices to receive, decode (if appropriate), and analyze the packets and CWs.

The actions illustrated in FIG. 7 begin at time T₀. At or before time T₀, the passive nodes begin listening and continue to listen throughout the CS and RTT procedure, which lasts at least from time T₀ to time T₉. During the elapsed time from T₀ to T₉, the passive nodes do not transmit in a way that may cause interference or otherwise affect the CS and RTT procedure.

At time T₁₀, the device 1 transmits packet (PKT1) 721, and at time T₁₁, device 2 receives packet 721. Furthermore, device 1 may begin counting clock ticks at time T₁₀ to correspond with transmission of packet 721. At time T₁₂, device 1 begins transmitting CW 722, and at time T₁₃, device 2 begins receiving CW 722.

The switching time (T_{SW}) represents a time for device 1 to switch from transmission to reception mode and for device 2 to switch from reception to transmission mode. TSW spans from time T₁₄ to time T₁₄.

At time T₁₅, device 2 begins transmitting CW 723, and at time T₁₆, device 1 begins receiving CW 723. At time T₁₈, device 2 may begin transmitting packet (PKT2) 724, and at time T₁₈, the device 1 may begin receiving packet 724. In some examples, packet 721 may be a synchronization packet, and packet 724 may be an acknowledgment packet, though the scope of embodiments may include any appropriate packet contents.

Device 1 may record a quantity of clock ticks that have occurred between time T₁₀ and time T₁₈, where that quantity of clock ticks may correspond to a time-of-flight, taking into account the switching time T_{SW}. The one or more passive nodes may also record and transmit a recorded quantity of clock ticks, representing a time between receiving packet 721 and packet 724. Device 1 may receive that transmitted recorded quantity of clock ticks.

Device 2 may send the measured phase ϕ2 of CW 722 to device 1 by any appropriate technique (e.g., Bluetooth, WiFi, wired connection, etc.). Additionally, the one or more passive nodes may also record and transmit measured local phases for CW 23. Device 1 may then receive the transmitted measured local phases from the one or more passive nodes. Device 1 may then calculate the phase shift θ using the measured phase ϕ1 of CW 723 and the measured phase ϕ2 of CW 722 received from device 2 (and received measured phases from the passive devices) and may convert the recorded clock tick counts to time. One or both of the phase shift and tick count (or time) may be converted to a distance measurement. Device 1 may then combine the phase shift measurement and the time-of-flight measurement by, for example, calculating an average or weighted average of the measurements depending on which of time-of-flight or phase shift should be accorded more weight. The measurements may also be compared and then discarded if not within a chosen range and/or of the same order of magnitude.

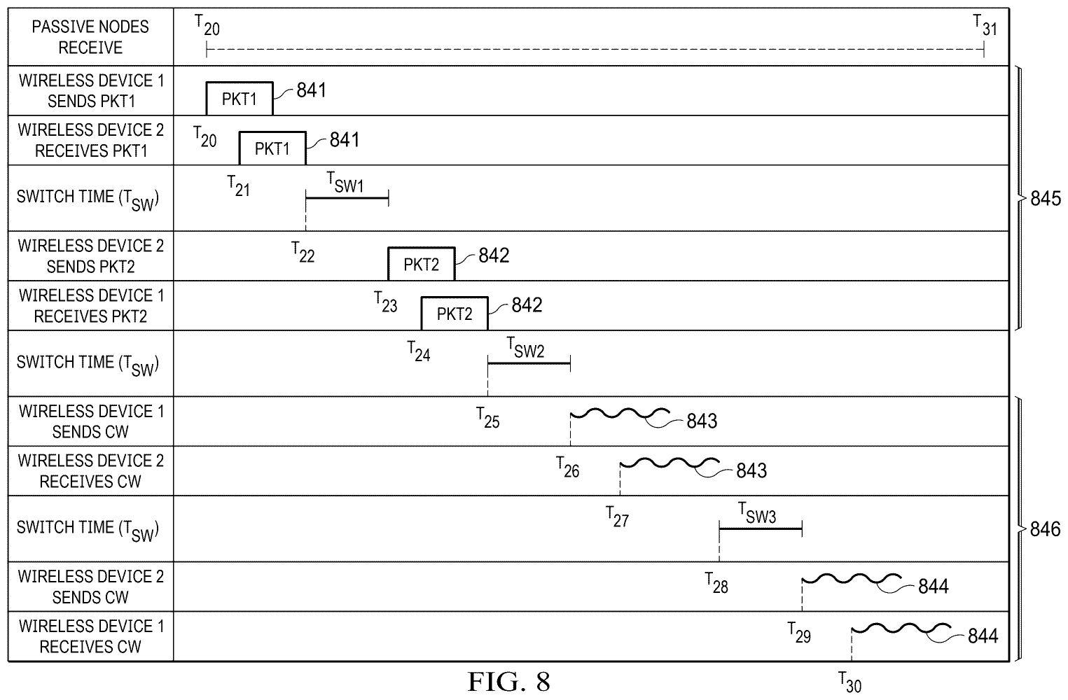

FIG. 8 illustrates a packet exchange 845, which is performed before a CW exchange 846. Compared to the procedure illustrated in FIG. 7, FIG. 8 incurs two additional switching times, T_{SW2} and T_{SW3}. Device 1 may calculate a spatial position of device 2 in a same or similar manner as described above with respect to FIG. 7.

In the example of FIG. 8, the passive nodes are configured to receive at least during the elapsed time from time T₂₀ to time T₃₁. At time T₂₀, device 1 transmits packet 841, and at time T₂₁, device 2 begins receiving packet 841. Between time T₂₂ and time T₂₃, device 1 switches from transmit mode to receive mode and device 2 switches from receive mode to transmit mode. At time T₂₃, device 2 begins transmitting packet 842, and at time T₂₄, device 1 begins receiving packet 842. The packet exchange 845 is at time T₂₅.

Another switching time spans the time from time T₂₄ to time T₂₅, and during that switching time, device 1 switches from receive mode to transmit mode and device 2 switches from transmit mode to receive mode. At time T₂₆, device 1 begins transmitting CW 843, and at time T₇ device 2 begins receiving CW 43. Then at time T₂₈, device 1 switches from transmitting mode to receiving mode and device 2 switches from receiving node to transmitting mode. At time T₂₉, device 2 begins transmitting CW 844, and at time T₃₀, device 1 begins receiving CW 844.

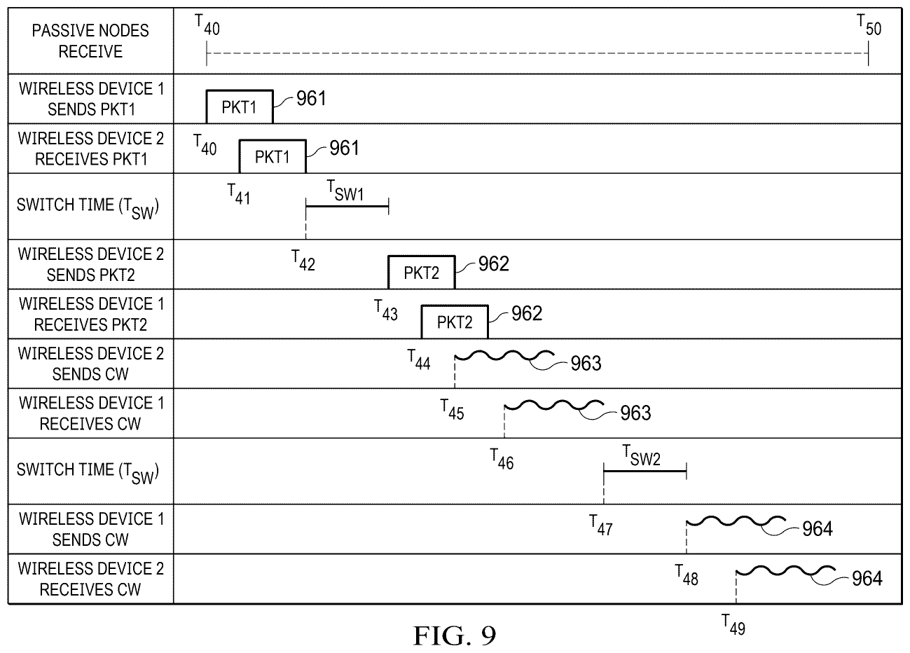

FIG. 9 shows a technique similar to that illustrated in FIG. 8, though in the technique of FIG. 9, device 2 transmits the first CW 963 of the phase measurement exchange, whereas in FIG. 8, device 1 sends the first CW 843 of the phase measurement exchange. The technique of FIG. 9 thus allows for the reduction of a single switching time relative to the technique of FIG. 8. Once again, the one or more passive nodes are configured to receive during the transmission and reception of packets and CWs (e.g., from time T₄₀ to time T₅₀). Device 1 may calculate a spatial position of device 2 in a same or similar manner as described above with respect to FIG. 7.

At time T₄₀, device 1 transmits packet 961, and at time T₄₁, device 2 begins receiving packet 961. At time T₄₂ begins a first switching time, after which device 2 begins transmitting packet 962 at time T₄₃. At time T₄₄, device 1 begins receiving packet 962. Device 2 is still in transmit mode, and device 1 is still in receive mode at time T₄₅. At time T₅, device 2 begins transmitting CW 963, and at time T₄₆ device 1 begins receiving CW 963.

There is another switching time between times T₄₇ and T₄₈ in which device 1 switches from receive mode to transmit mode and device 2 switches from transmit mode to receive mode. At time T₄₈, device 1 transmits CW 964, and at time T₄₉, device 2 begins receiving CW 964.

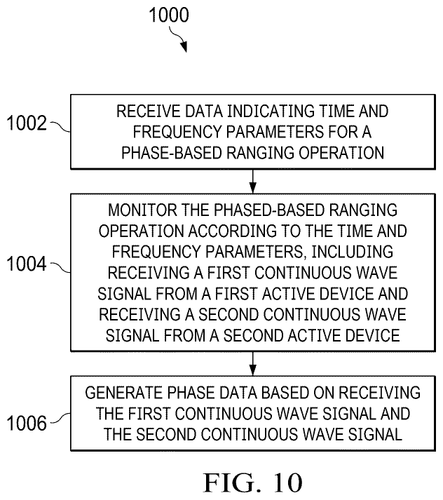

FIG. 10 is an illustration of an example method 1000, for operation of a device configured as a passive node, according to some embodiments. In one example, the method 1000 may be performed by a device, such as device 1 or device 2 of FIG. 1, which may execute computer readable code to perform actions to provide the functionality of a passive node. Examples of passive nodes include those described above with respect to FIGS. 2-9.

At action 1002, the device receives data indicating time and frequency parameters for a phase-based ranging operation. In one example, the device may receive the data indicating time and frequency parameters out-of-band, such as by being pre-programmed with the time and frequency parameters, receiving the time and frequency parameters via a wired connection separate from a wireless protocol associated with the time and frequency parameters, and/or the like. The time and frequency parameters may indicate one or more channels and one or more times (e.g., time offsets) to receive a CW, where examples of CWs include CWs 603, 605, and 606 of FIG. 6, CWs 722 and 723 of FIG. 7, CWs 843 and 844 of FIG. 8, and CWs 963 and 964 of FIG. 9.

Furthermore, action 1002 may also include receiving time and frequency parameters for an RTT operation, such as channel and timing for synchronization packet reception. Examples of packets for an RTT operation are described above with respect to packets 601, 602, 604, 607 of FIG. 6, 721 and 724 of FIG. 7, 841 and 842 of FIG. 8, and 961 and 962 of FIG. 9.

At action 1004, the device may monitor the phase-based ranging operation according to the time and frequency parameters. For instance, the device may tune its local oscillator to cause its receiver to receive the CW in the appropriate wireless channel (frequency domain) and at designated times (time domain) to receive and analyze CWs sent by other devices. The other devices may be active nodes, such as an initiator and a reflector, which transmit and receive CWs. For instance, in the examples above, a first active node may transmit a first CW, and a second active node may transmit a second CW, thereby allowing the first and second devices to generate phase information, such as local oscillator offset information. Action 1004 may include the device receiving the first CW and the second CW.

Action 1004 may include the device avoiding interfering in the CS procedure between the first active node and the second active node according to a wireless protocol defining the CS procedure. For instance, the CS procedure may be performed according to a protocol, such as BLE or Wi-Fi, and the device may operate according to that protocol and may avoid interfering in the CS procedure. Avoiding interfering in the CS procedure may include avoiding transmitting, at least within the same channel and during the same times as the transmissions of the first CW and the second CW. Avoiding interfering may also include operating in a receive-only mode at least during the CS procedure. Of course, that does not exclude that the device may operate in a transmission mode outside of an elapsed time of the CS procedure, in a different channel that does not experience interference with the channel(s) for the first CW and the second CW, transmitting on a wired medium, and/or the like.

Furthermore, while the device operates as a passive device for the CS procedure, that does not exclude that the device may have an active operation in other roles, such as participating in connection events with other devices in ways that do not interfere with the CS procedure. For example, in some embodiments, the passive device with respect to a particular CS procedure may operate as an initiator or reflector in another CS procedure, e.g., occurring during a different (e.g., non-overlapping) window of time.

Action 1006 may include generating phase data based on receiving the first CW and the second CW. For instance, the device may analyze the first CW, and, based on the analyzing, generate a first PCT based on a first phase of a local oscillator of the device relative to the first CW. The device may also analyze the second CW, and, based on the analyzing, generate a second PCT based on a second phase of the local oscillator of the device relative to the second CW. PCTs are described in more detail above with respect to Equations 9 and 10.

While actions 1004 and 1006 are described as being performed with respect to one or more channels, the scope of implementations may include multiple CS procedures on a multitude of different channels, where the device may monitor such CS procedures and generate phase data accordingly.

Action 1006 may further include transmitting the phase data to another device. The device may transmit the phase data to a reflector (e.g., 204 of FIG. 2), an initiator (e.g., 202 of FIG. 2), a control circuit (e.g., 310 of FIG. 3), another passive device (e.g., any other device to 12, 214, 216 of FIG. 2), or other appropriate device. The other device may be configured to calculate distance and (from distance) a spatial position of either the first active device or the second active device based on the phase data.

Transmitting the phase data from the device to another device may include the device transmitting according to the same wireless protocol as is associated with the CS procedure, a different wireless protocol, a wired protocol (e.g., CAN bus protocol), or other appropriate technique.

Spatial position may be calculated using any appropriate technique, such as triangulation. In one example, an initiator is fixed (position known), and a passive device is fixed (position known). The reflector has an unknown distance and location, and the initiator is configured to determine the spatial location of the reflector. The passive device monitors a channel sounding procedure between the initiator and the reflector. The passive device generates phase data based on monitoring the channel sounding procedure, and the passive device transmits that phase data to the initiator.

The initiator then calculates a first distance between the initiator and the reflector and a second distance between the passive device and the reflector. Spatial position calculations may employ a further device with a known location so that there are at least three distances that can be used in the calculation. Thus, method 1000 may include a second passive device (fixed, position known) that monitors the channel sounding procedure and returns phase data to the initiator. This allows the initiator to calculate a third distance between the second passive device and the reflector. The initiator may then use triangulation based on the known positions and the first, second, and third distances to calculate a spatial position of the reflector.

As noted above, in some embodiments the relationship of the initiator to the reflector may be one in which the reflector has a fixed, known position, e.g., with respect to a predetermined reference point, and the initiator has an unknown distance and position. The spatial position calculation discussion above applies in the same way but begins by calculating positions to the initiator. Furthermore, the calculations may be performed by another device, such as a control circuit or a passive device, which is configured to receive phase data from the other nodes.

The device that calculates the spatial position, which may be different from the device performing actions 1002-1006, may be configured to use the calculated spatial position for any of a variety of different purposes. Such purposes may include providing or denying access to an automobile (as in the example of FIG. 3), providing or denying access to a door (as in the example of FIG. 4), tracking physical goods in a commercial setting, such as a warehouse (as in the example of FIG. 5,) and/or the like.

Example embodiments of the present disclosure are summarized here. Other embodiments may also be understood from the entirety of the specification and the claims filed herein.

Example 1. An electronic device including: a processor; and a wireless communication interface coupled to the processor, where the processor is configured to: receive control data indicating time and frequency parameters for a phase-based ranging operation between a first wireless device and a second wireless device; monitor, using the wireless communication interface, the phased-based ranging operation between the first and second wireless devices according to the time and frequency parameters, including receiving a first continuous wave signal from the first wireless device and receiving a second continuous wave signal from the second device, via the communication interface; and generate phase data based on receiving the first continuous wave signal and the second continuous wave signal.

Example 2. The electronic device of example 1, where the processor is configured to: operate the wireless communication interface in a receive-only mode during a time period that includes: the first wireless device transmitting the first continuous wave signal and the second wireless device receiving the first continuous wave signal, and the second wireless device transmitting the second continuous wave signal and the first wireless device receiving the second continuous wave signal.

Example 3. The electronic device of one of examples 1 or 2, where the processor is configured to avoid interfering in a channel sounding procedure between the first wireless device and the second wireless device according to a wireless protocol defining the channel sounding procedure while monitoring the phased-based ranging operation between the first and second wireless devices.

Example 4. The electronic device of one of examples 1 to 3, where the processor is configured to transmit the phase data to the first wireless device via a wired medium.

Example 5. The electronic device of one of examples 1 to 4, where the processor is configured to transmit the phase data to the second device via a wireless protocol.

Example 6. The electronic device of one of examples 1 to 5, where the processor is configured to transmit the phase data to the first wireless device via the wireless protocol using the wireless communication interface.

Example 7. The electronic device of one of examples 1 to 6, where the processor is configured to receive the first and second continuous wave signals via the wireless protocol.

Example 8. The electronic device of one of examples 1 to 7, where the processor is configured to transmit the phase data to a controlling device, which is separate from the first and second wireless devices, via a wired medium.

Example 9. The electronic device of one of examples 1 to 8, where the processor is configured to transmit the phase data to a controlling device, which is separate from the first and second wireless devices, via a wireless protocol.

Example 10. The electronic device of one of examples 1 to 9, where the processor is configured to: determine a first phase of a local oscillator (LO) of the electronic device at a time at which the first continuous wave signal is received; and determine a second phase of the LO at a time at which the second continuous wave signal is received.

Example 11. The electronic device of one of examples 1 to 10, where the processor is configured to: calculate a first phase correction term based on a first phase of a local oscillator (LO) of the electronic device relative to the first continuous wave signal; calculate a second phase correction term based on a second phase of the LO relative to the second continuous wave signal; and generate the phase data based on the first and second phase correction terms.

Example 12. The electronic device of one of examples 1 to 11, where the processor is configured to transmit the first phase correction term and the second phase correction term to the first wireless device.

Example 13. The electronic device of one of examples 1 to 12, where the processor is configured to transmit the first phase correction term and the second phase correction term to a controlling device, which is separate from the first and second wireless devices.

Example 14. The electronic device of one of examples 1 to 13, where the processor is configured to: receive further phase data from the first and second wireless devices; and calculate a first distance from the electronic device to the first wireless device based on the further phase data.

Example 15. The electronic device of one of examples 1 to 14, where the processor is configured to determine a position in space of the first wireless device based on the first distance, a second distance from the electronic device to the second wireless device, and another distance from a third device to the electronic device.

Example 16. The electronic device of one of examples 1 to 15, where the processor is configured to receive the first continuous wave signal according to a wireless protocol in which the first wireless device operates as an initiator.

Example 17. The electronic device of one of examples 1 to 16, where the processor is configured to receive the first continuous wave signal according to a wireless protocol in which the second device operates as a reflector.

Example 18. The electronic device of one of examples 1 to 17, where the electronic device includes a component affixed to an automobile.

Example 19. The electronic device of one of examples 1 to 18, the processor is configured to receive the first continuous wave signal from a key fob or smart phone.

Example 20. The electronic device of one of examples 1 to 19, where the processor is configured to receive the time and frequency parameters from the first wireless device via a wireless protocol.

Example 21. The electronic device of one of examples 1 to 20, where the processor is configured to receive the time and frequency parameters from the first wireless device via wired communication.

Example 22. The electronic device of one of examples 1 to 21, the processor is configured to receive the time and frequency parameters from a controlling device, which is separate from the first and second wireless devices, via a wireless protocol.

Example 23. The electronic device of one of examples 1 to 22, where the processor is configured to receive the time and frequency parameters from a controlling device, which is separate from the first and second wireless devices, via wired communication.

Example 24. The electronic device of one of examples 1 to 23, where the control data includes an indication of a channel hopping sequence and timing data associated with the first wireless device.

Example 25. The electronic device of one of examples 1 to 24, where the electronic device is included in a door access system.

Example 26. The electronic device of one of examples 1 to 25, where the electronic device is included in an inventory tracking system.

Example 27. The electronic device of one of examples 1 to 26, where frequencies of the first and second continuous wave signals are randomized according to a first sequence, and where the control data is indicative of the first sequence.

Example 28. The electronic device of one of examples 1 to 27, where the first continuous wave signal is received before or after a synchronization packet transmitted between the first and second wireless devices.

Example 29. The electronic device of one of examples 1 to 28, where the synchronization packet is a round trip time (RTT) packet.

Example 30. The electronic device of one of examples 1 to 29, where the processor is configured to ignore the synchronization packet.

Example 31. The electronic device of one of examples 1 to 30, where the processor is configured to determine time-of-flight data indicative of a distance between the first and second wireless devices based on the synchronization packet.

Example 32. The electronic device of one of examples 1 to 31, where the control data includes an encryption key associated with packet transmissions between the first and second wireless devices during the phased-based ranging operation.

Example 33. The electronic device of one of examples 1 to 32, where monitoring the phased-based ranging operation between the first and second wireless devices includes periodically receiving continuous wave signals from the first and second wireless devices.

Example 34. The electronic device of one of examples 1 to 33, where the phased-based ranging operation is a phased-based ranging operation according to a Bluetooth Low Energy (BLE) protocol.

Example 35. A system including: a first device configured to perform a channel sounding procedure, including transmitting a first continuous wave signal, and receiving a second continuous wave signal from a second device; and a third device configured to monitor the channel sounding procedure, including determining a first phase associated with the first continuous wave signal and a second phase associated with the second continuous wave signal.

Example 36. The system of example 35, where the system is a vehicle.

Example 37. The system of one of examples 35 or 36, where a physical distance between the first and third devices is fixed.

Example 38. The system of one of examples 35 to 37, where the first device is configured to transmit the first continuous wave signal before receiving the second continuous wave signal.

Example 39. The system of one of examples 35 to 38, where the first device is configured to transmit the first continuous wave signal after receiving the second continuous wave signal.

Example 40. The system of one of examples 35 to 39, where the channel sounding procedure is performed according to a channel hopping sequence, where the third device is configured to receive frequency and timing parameters defining the channel hopping sequence and is further configured to listen to the channel sounding procedure according to the frequency and timing parameters.

Example 41. The system of one of examples 35 to 40, where the third device is configured to avoid wireless transmissions during the channel sounding procedure.

Example 42. The system of one of examples 35 to 41, where the third device is configured to avoid interfering in the channel sounding procedure, according to a wireless protocol defining the channel sounding procedure.

Example 43. The system of one of examples 35 to 42, where the third device is configured to transmit phase data, including results of determining the first phase and the second phase, to the first device, according to a wireless protocol.

Example 44. The system of one of examples 35 to 43, where the third device is configured to transmit phase data, including results of determining the first phase and the second phase, to the first device, via wired communication.

Example 45. The system of one of examples 35 to 44, where the third device is configured to transmit phase data, including results of determining the first phase and the second phase, to the second device, according to a wireless protocol.

Example 46. The system of one of examples 35 to 45, where the third device is configured to transmit phase data, including results of determining the first phase and the second phase, to a controlling device that is separate from the first device and the second device, according to a wireless protocol.

Example 47. The system of one of examples 35 to 46, where the third device is configured to transmit phase data, including results of determining the first phase and the second phase, to a controlling device that is separate from the first device and the second device, via wired communication.

Example 48. The system of one of examples 35 to 47, where the first device is configured to receive phase data, including results of determining the first phase and the second phase, and to calculate a distance from the first device to the second device and a distance from the second device to the third device based on the phase data.

Example 49. The system of one of examples 35 to 48, where the first device is further configured to determine a spatial position of the second device based on the distance from the first device to the second device and based on the distance from the second device to the third device and further based on a distance from the second device to a fourth device.

Example 50. The system of one of examples 35 to 49, where the first device is further configured to determine whether to provide access to an automobile or a door based on the spatial position

Example 51. The system of one of examples 35 to 50, where the system is configured to receive from the second device a distance from the second device to the first device and from the first device to the third device based on the phase data.

Example 52. The system of one of examples 35 to 51, further including a fourth device, where the fourth device is configured to: receive phase data, including results of determining the first phase and the second phase; receive channel sounding data from the first device and from the second device; and determine a spatial position of the second device from the channel sounding data and the phase data.

Example 53. The system of one of examples 35 to 52, where the fourth device is further configured to determine whether to provide access to an automobile or a door based on the spatial position.

Example 54. The system of one of examples 35 to 53, where the first device is configured to operate as an initiator, according to a wireless protocol.

Example 55. The system of one of examples 35 to 54, where the first device is configured to operate as a reflector, according to a wireless protocol.

Example 56. The system of one of examples 35 to 55, where the first device is configured to transmit the first continuous wave signal to the second device during a connection event between the first device and the second device, and receive the second continuous wave signal during the connection event.

Example 57. The system of one of examples 35 to 56, where the third device is configured to listen to the first continuous wave signal and to the second continuous wave signal during a time period in which the third device does not have a connection event with either the first device or the second device.

Example 58. The system of one of examples 35 to 57, where the channel sounding procedure is a channel sounding procedure according to a Bluetooth Low Energy (BLE) protocol.

Example 59. An electronic device including: a processor; and a communication interface coupled to the processor, where the processor is configured to: perform a tone exchange, via the communication interface, with a first wireless device during a connection event between the electronic device and the first wireless device; determine a first distance from the electronic device to the first wireless device based on the tone exchange; receive phase data from a second wireless device, where the phase data from the second wireless device is based on the continuous wave signals of the tone exchange relative to a local oscillator of the second wireless device, and where the connection event is exclusive of the second wireless device; receive phase data from a third wireless device, where the phase data from the third wireless device is based on the continuous wave signals of the tone exchange relative to a local oscillator of the third wireless device, and where the connection event is exclusive of the third wireless device; determine a second distance from the second wireless device to the first wireless device based on the phase data from the second wireless device; determine a third distance from the third wireless device to the first wireless device based on the phase data from the third wireless device; and determine a spatial position of the first wireless device based on the first, second, and third distances.

Example 60. The electronic device of example 59, where the electronic device is configured to operate as an initiator according to a wireless protocol.

Example 61. The electronic device of one of examples 59 or 60, where the electronic device is configured to operate as a reflector according to a wireless protocol.

Example 62. The electronic device of one of examples 59 to 61, where the electronic device includes a memory storing first data indicating a position of the second wireless device and a position of the third wireless device, and where the processor is configured to determine the spatial position of the first wireless device based on the stored first data.

Example 63. The electronic device of one of examples 59 to 62, where the processor is configured to: perform the tone exchange according to channel hopping parameters; and transmit the channel hopping parameters to the second wireless device prior to the tone exchange.

Example 64. The electronic device of one of examples 59 to 63, where the processor is configured to transmit the channel hopping parameters to the second wireless device via a wireless protocol associated with the channel hopping parameters.

Example 65. The electronic device of one of examples 59 to 64, where the processor is configured to transmit the channel hopping parameters to the second wireless device via a wired communication.

Example 66. The electronic device of one of examples 59 to 65, where the processor is configured to receive the phase data from the second wireless device via a wireless protocol associated with the tone exchange.

Example 67. The electronic device of one of examples 59 to 66, where the processor is configured to receive the phase data from the second wireless device via a wired communication.

Example 68. The electronic device of one of examples 59 to 67, where the processor is configured to transfer data indicative of the spatial position of the first wireless device to an access control device.

Example 69. The electronic device of one of examples 59 to 68, where the processor is further configured to determine whether to grant access to a door or a car based on the spatial position of the first wireless device.

Example 70. The electronic device of one of examples 59 to 69, where the processor is further configured to track physical inventory having a position associated with the spatial position of the first wireless device.

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. An electronic device comprising:
a processor; and
a wireless communication interface coupled to the processor, wherein the processor is configured to:
receive control data indicating time and frequency parameters for a phase-based ranging operation between a first wireless device and a second wireless device;
monitor, using the wireless communication interface, the phased-based ranging operation between the first and second wireless devices according to the time and frequency parameters, including receiving a first continuous wave signal from the first wireless device and receiving a second continuous wave signal from the second device, via the communication interface; and
generate phase data based on receiving the first continuous wave signal and the second continuous wave signal.

2. The electronic device of claim 1, wherein the processor is configured to:
operate the wireless communication interface in a receive-only mode during a time period that includes:
the first wireless device transmitting the first continuous wave signal and the second wireless device receiving the first continuous wave signal, and
the second wireless device transmitting the second continuous wave signal and the first wireless device receiving the second continuous wave signal.

3. The electronic device of claim 1, wherein the processor is configured to avoid interfering in a channel sounding procedure between the first wireless device and the second wireless device according to a wireless protocol defining the channel sounding procedure while monitoring the phased-based ranging operation between the first and second wireless devices.

4. The electronic device of claim 1, wherein the processor is configured to transmit the phase data to the first wireless device via a wired medium and to transmit the phase data to the second device via a wireless protocol.

5. The electronic device of claim 4, wherein the processor is configured to transmit the phase data to the first wireless device via the wireless protocol using the wireless communication interface.

6. The electronic device of claim 4, wherein the processor is configured to receive the first and second continuous wave signals via the wireless protocol.

7. The electronic device of claim 1, wherein the processor is configured to transmit the phase data to a controlling device, which is separate from the first and second wireless devices, via a wired medium or a wireless protocol.

8. The electronic device of claim 1, wherein the processor is configured to:
determine a first phase of a local oscillator (LO) of the electronic device at a time at which the first continuous wave signal is received; and
determine a second phase of the LO at a time at which the second continuous wave signal is received.

9. The electronic device of claim 1, wherein the processor is configured to:
calculate a first phase correction term based on a first phase of a local oscillator (LO) of the electronic device relative to the first continuous wave signal;
calculate a second phase correction term based on a second phase of the LO relative to the second continuous wave signal; and
generate the phase data based on the first and second phase correction terms.

10. The electronic device of claim 9, wherein the processor is configured to transmit the first phase correction term and the second phase correction term to the first wireless device.

11. The electronic device of claim 9, wherein the processor is configured to transmit the first phase correction term and the second phase correction term to a controlling device, which is separate from the first and second wireless devices.

12. The electronic device of claim 1, wherein the processor is configured to:
receive further phase data from the first and second wireless devices; and
calculate a first distance from the electronic device to the first wireless device based on the further phase data.

13. The electronic device of claim 12, wherein the processor is configured to determine a position in space of the first wireless device based on the first distance, a second distance from the electronic device to the second wireless device, and another distance from a third device to the electronic device.

14. The electronic device of claim 1, wherein the electronic device comprises a component affixed to an automobile or is included in a door access system or is included in an inventory tracking system

15. The electronic device of claim 1, the processor is configured to receive the first continuous wave signal from a key fob or smart phone.

16. The electronic device of claim 1, wherein the processor is configured to:
receive the time and frequency parameters from the first wireless device via a wireless protocol or via wired communication; or
receive the time and frequency parameters from a controlling device, which is separate from the first and second wireless devices, via a wireless protocol or via wired communication.

17. The electronic device of claim 1, wherein the control data comprises an indication of a channel hopping sequence and timing data associated with the first wireless device.

18. The electronic device of claim 1, wherein frequencies of the first and second continuous wave signals are randomized according to a first sequence, and wherein the control data is indicative of the first sequence.

19. The electronic device of claim 1, wherein the first continuous wave signal is received before or after a synchronization packet transmitted between the first and second wireless devices.

20. The electronic device of claim 19, wherein the synchronization packet is a round trip time (RTT) packet.

21. The electronic device of claim 19, wherein the processor is configured to ignore the synchronization packet.

22. The electronic device of claim 19, wherein the processor is configured to determine time-of-flight data indicative of a distance between the first and second wireless devices based on the synchronization packet.

23. The electronic device of claim 1, wherein the control data comprises an encryption key associated with packet transmissions between the first and second wireless devices during the phased-based ranging operation.

24. The electronic device of claim 1, wherein monitoring the phased-based ranging operation between the first and second wireless devices comprises periodically receiving continuous wave signals from the first and second wireless devices.

25. The electronic device of claim 1, wherein the phased-based ranging operation is a phased-based ranging operation according to a Bluetooth Low Energy (BLE) protocol.

26. A system comprising:
a first device configured to perform a channel sounding procedure, including transmitting a first continuous wave signal, and receiving a second continuous wave signal from a second device; and
a third device configured to monitor the channel sounding procedure, including determining a first phase associated with the first continuous wave signal and a second phase associated with the second continuous wave signal.

27. An electronic device comprising:
a processor; and
a communication interface coupled to the processor, wherein the processor is configured to:
perform a tone exchange, via the communication interface, with a first wireless device during a connection event between the electronic device and the first wireless device;
determine a first distance from the electronic device to the first wireless device based on the tone exchange;
receive phase data from a second wireless device, wherein the phase data from the second wireless device is based on the continuous wave signals of the tone exchange relative to a local oscillator of the second wireless device, and wherein the connection event is exclusive of the second wireless device;
receive phase data from a third wireless device, wherein the phase data from the third wireless device is based on the continuous wave signals of the tone exchange relative to a local oscillator of the third wireless device, and wherein the connection event is exclusive of the third wireless device;
determine a second distance from the second wireless device to the first wireless device based on the phase data from the second wireless device;
determine a third distance from the third wireless device to the first wireless device based on the phase data from the third wireless device; and
determine a spatial position of the first wireless device based on the first, second, and third distances.
